(19) United States
(12) Patent Application Publication
(10) Pub. No.: US 2026/0172942 A1
(43) Pub. Date: Jun. 18, 2026

(54) METHOD OF UE REPORTING FOR URSP RULE ENFORCEMENT

(71) Applicant: GOOGLE LLC, Mountain View, CA (US)

(72) Inventors: Ching-yu Liao, Mountain View, CA (US); Pavan Nuggehalli, Mountain View, CA (US)

(21) Appl. No.: 19/124,971

(22) PCT Filed: Oct. 31, 2023
(86) PCT No.: PCT/US23/36333

§ 371 Date: Apr. 28, 2025

Related U.S. Application Data
(60) Provisional application No. 63/381,760, filed on Oct. 31, 2022.

(51) Int. Cl. H04W 40/02; H04L 43/062; H04L 65/1016

(52) U.S. Cl. CPC H04W 40/026; H04L 43/062; H04L 65/1016

(57) ABSTRACT

A user equipment (UE) running an application can implement a method for managing reporting for a route selection policy for the UE. The method includes: (i) evaluating a selection policy rule received (302) from a core network (CN) node; (ii) determining (304), based on the evaluation of the selection policy rule, that a traffic descriptor for the selection policy rule is associated with an application descriptor for the application; and (iii) transmitting (306), in response to the determining, reporting information to the CN node in accordance with the selection policy rule.

### CROSS-REFERENCE TO RELATED APPLICATIONS

This application claims priority to and the benefit of the filing date of provisional U.S. Patent Application No. 63/381,760 entitled “METHOD OF UE REPORTING FOR URSP RULE ENFORCEMENT,” filed on Oct. 31, 2022. The entire contents of the provisional application are hereby expressly incorporated herein by reference.

### FIELD OF THE DISCLOSURE

This disclosure relates generally to wireless communications and, more particularly, to applying rules for routing outgoing traffic at a user device.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In wireless communication systems, a user equipment (UE) can apply a UE Route Selection Policy (URSP) to outgoing traffic to determine how the UE should route traffic for a certain application executing on an operating system (OS), a certain domain, a certain network host, etc. A URSP rule may include (1) a rule precedence value, (2) one or more traffic descriptors (TDs), and/or (3) one or more route selection descriptors (RSDs). Rule precedence values determine the order in which the UE applies the URSP rules, traffic descriptors specify how the UE should match outgoing traffic to the rule to determine whether the rule applies, and route selection descriptors specify how the UE should route the traffic if the rule applies.

For example, according to a first URSP rule, a UE should route traffic related to network domain D to the already-established Protocol Data Unit (PDU) session; according to a second URSP rule, the UE should establish a new PDU session for outgoing traffic addressed to host H; and according to a third URSP rule, the UE should offload all Ethernet traffic to a wireless local area network (WLAN) such as a Wi-Fi network. If the first rule in this example has a higher rule precedence value than the second rule, the UE should apply the first rule rather than the second rule to the outgoing traffic that matches the respective traffic descriptors of the first and second rules (i.e., the traffic relates to domain D and is addressed to host H).

A UE can locally store pre-provisioned URSP rules and also receive URSP rules from the core network (CN). When the UE has both pre-provisioned rules and CN-specified rules, the UE may apply the CN-specified rules.

Questions remain as to whether and how the network can become aware of when the UE enforces URSP rule(s) for certain traffic. More specifically, the question remains regarding how a CN can, after provisioning a URSP rule to a UE, determine whether and when the UE enforces the CN-specified URSP rule to route application traffic to a PDU Session based on this rule.

According to one approach, if a URSP rule includes an Application Descriptor in the TD, and the URSP rule is matched based on the Application Descriptor, the UE reports the Application Descriptor in the PDU Session Establishment or Modification when the URSP rule is matched. The UE does not report information to the CN when a “match-all” URSP rule is enforced. Alternatively, the UE can use a new identifier, such as a URSP Rule ID, and incorporate the URSP Rule ID into each of the URSP rules as the identifier for a URSP rule. The UE can report the URSP rule ID for the enforced URSP rule to the network when the URSP rule is matched, and when the UE applies the rule, in the PDU Session establishment or modification.

However, if the UE needs to report enforced URSP rule information in a PDU Session Establishment/Modification procedure, the UE generates a significant amount of signaling with the network. For example, there may be more than one application that can map to a URSP rule. Whenever an application matches a specific URSP rule, the UE indicates reporting information that is associated with the enforced URSP rule (e.g., an application descriptor or URSP rule ID of the enforced URSP rule). The UE thus generates a significant amount of signaling overhead to report the enforced URSP rules.

Thus, it is desirable to provide a mechanism that would allow URSP reporting for a limited number of UEs, a limited number of occasions, and/or a limited number of traffic instances and/or applications, thereby reducing the amount of signaling.

Further, when a CN is aware of a UE enforcing a URSP rule that routes certain application traffic to a PDU Session, the CN may be able to determine the association between the UE and the application. Such an ability is not desirable from the standpoint of user privacy if the UE does not consent to revealing such an association to the network and network operators. Thus, there is a further need for a mechanism to ensure that the user has consented to UE reporting of an enforced URSP rule.

### SUMMARY

The techniques discussed address at least the problem discussed above. In particular, to support UE reporting of an enforced URSP rule, these techniques provide a mechanism to ensure that UE reporting functionality is available for a limited number of UEs, a limited number of occasions, and a limited number of traffic instances and/or applications, to reduce the amount of signaling. These techniques also provide mechanism to ensure that the user has consented to UE reporting of an enforced URSP rule.

One example embodiment is a method, implemented in a UE, for managing reporting for a route selection policy for a UE running an application. The method includes evaluating a route selection policy rule received from a core network (CN) node; determining, based on the evaluation of the route selection policy rule, that a traffic descriptor for the route selection policy rule includes one or more connection capabilities; and transmitting, in response to the determining, reporting information to the CN node in accordance with the route selection policy rule.

Another example embodiment of these techniques is a method, implemented in a CN, for managing reporting for a route selection policy for a UE running an application. The method includes configuring, by the processing hardware, a route selection policy rule including a traffic descriptor that includes one or more connection capabilities of the UE; transmitting, by the processing hardware, the configured route selection policy rule to the UE; and receiving, by the processing hardware when the traffic descriptor includes the one or more connection capabilities of the UE, reporting information from the UE based on the configured route selection policy rule.

### BRIEF DESCRIPTION OF THE DRAWINGS

FIG. 1 illustrates an example communication system in which the routing techniques of this disclosure can be implemented;

FIG. 2 is a block diagram of an example rule for route selection which the UE of FIG. 1 can apply to outgoing traffic;

FIG. 3 is a messaging diagram of an example scenario in which a UE reports traffic categories of an enforced UE route selection policy to a CN, which can be implemented in the system of FIG. 1;

FIG. 4 is a messaging diagram of an example scenario similar to the scenario of FIG. 3, but in which the UE reports for enforced UE route selection policies that include a reporting indication, which can be implemented in the system of FIG. 1;

FIG. 5 is a messaging diagram of an example scenario similar to the scenario of FIG. 3, but in which the UE reports for enforced UE route selection policies after fulfilling validity conditions associated with the policies, which can be implemented in the system of FIG. 1;

FIG. 6 is a messaging diagram of an example scenario similar to the scenario of FIG. 3, but in which a reporting preference for the UE takes precedence when the UE determines whether to report to the CN, which can be implemented in the system of FIG. 1;

FIG. 7 is a messaging diagram of an example scenario similar to the scenario of FIG. 3, but in which the CN configures the UE route selection policies with a reporting indication or descriptor based on UE subscription information, which can be implemented in the system of FIG. 1;

FIG. 8A is a messaging diagram of an example scenario in which a UE and a CN perform a registration procedure and the UE provides information regarding UE reporting capabilities to the CN, which can be implemented in the system of FIG. 1;

FIG. 8B is a messaging diagram of an example scenario similar to the scenario of FIG. 3, but in which the CN configures the UE route selection policies based on the UE reporting capabilities, which can be implemented in the system of FIG. 1;

FIG. 9A is a messaging diagram of an example scenario similar to the scenario of FIG. 8A, but in which the UE provides information regarding subscriber consent to the CN, which can be implemented in the system of FIG. 1;

FIG. 9B is a messaging diagram of an example scenario similar to the scenario of FIG. 3, but in which the CN configures the UE route selection policies based on subscriber consent, which can be implemented in the system of FIG. 1;

FIG. 10 is a flow diagram of an example method 1000, where a UE supports a route selection policy, which can be implemented in the system of FIG. 1; and

FIG. 11 is a flow diagram of an example method 1100, where a CN supports a route selection policy for a UE, which can be implemented in the system of FIG. 1.

### DETAILED DESCRIPTION OF THE DRAWINGS

A UE manages reporting to a core network (CN) node for a UE route selection policy (URSP) for a UE running an application. The UE evaluates a route selection policy rule received from the CN node. The UE then determines, based on the evaluation of the route selection policy rule, that a traffic descriptor (TD) for the route selection policy rule includes one or more connection capabilities. The UE then transmits, in response to the determining, reporting information to the CN node in accordance with the route selection policy rule.

A CN node similarly manages reporting for a URSP rule for a UE running an application. In particular, the CN node configures a URSP rule including a traffic descriptor that includes one or more connection capabilities of the UE. The CN node transmits the configured URSP rule to the UE. The CN then receives reporting information from the UE based on the configured route selection policy rule when the traffic descriptor includes the one or more connection capabilities of the UE.

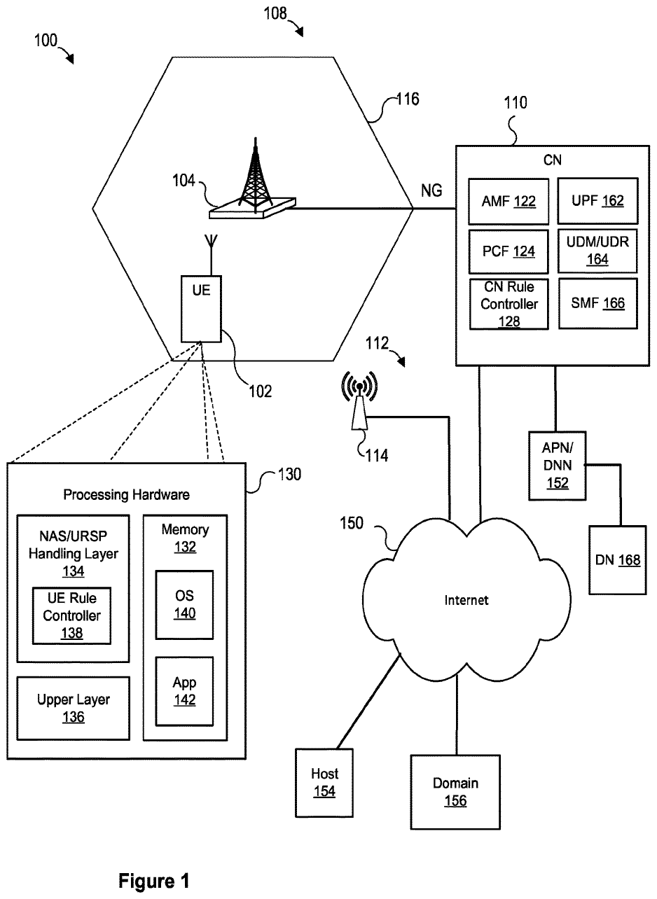

FIG. 1 illustrates an example communication system 100 in which the routing techniques of this disclosure can be implemented. The communication system 100 includes a user equipment (UE) 102, which can be any suitable device capable of wireless communications with a core network (CN) 110 via a base station 104.

Generally speaking, the UE 102 can determine that certain traffic descriptors associated with rules that specify route selection for outgoing traffic at the UE 102 are proscribed (or “forbidden”), and that the UE 102 should not use these proscribed descriptors when matching the outgoing traffic to the rules. Although the disclosure refers primarily to URSP rules, these techniques also can apply to other rule-based routing mechanisms.

As discussed in more detail below, the UE 102 can determine that a rule includes a proscribed traffic descriptor and subsequently ignore the rule when applying the set of rules of an URSP. As another example, the UE 102 can determine that a rule contains both proscribed and non-proscribed, or permissible, traffic descriptors. The UE 102 then can apply the rule by ignoring the proscribed traffic descriptors and using only the permissible traffic descriptors for matching the outgoing traffic.

In another example implementation, the UE 102 is allowed to prioritize a local configuration over URSP rules received from the CN 110. For instance, the UE 102 can apply local rules over those rules that include proscribed traffic descriptors or can prioritize a local set of rules in its entirety over the URSP rules received from the CN 110.

Still further, the UE 102 can preemptively request that the CN 110 not supply the UE 102 with any URSP rules that include the proscribed traffic descriptors. For example, the UE 102 can determine that a certain traffic descriptor is proscribed and transmit a corresponding indication to the CN 110. To this end, the UE 102 can use an existing protocol for managing URSP rules or use a dedicated message for indicating proscribed traffic descriptors.

The UE also can combine at least some of these techniques. For example, if the UE 102 sends an indication of a proscribed traffic descriptor to the CN 110, but the CN 110 nevertheless responds with URSP rules containing proscribed traffic descriptors (for example, due to a race condition or because the CN 110 does not support the message from the UE 102), the UE 102 can apply the other techniques discussed above to prevent application of any rules that contain forbidden traffic descriptors. As another example, the UE 102 can ignore rules that reference only proscribed traffic descriptors, but still apply rules that reference both proscribed and permissible traffic descriptors by utilizing only the permissible traffic descriptors. In at least some of the implementations, the UE 102 can consider the rules that reference one or more proscribed traffic descriptors as inapplicable.

As illustrated in FIG. 1, the base station 104 is communicatively connected to a core network (CN) 110 via an NG interface, for example. In some implementations, the base station 104 is a 5G New Radio (NR) base station operating as a g Node B (gNB), and the CN 110 is a 5G core network (5GC). In other implementations, however, the communication system 100 can include one or more base stations that operate according to radio access technologies (RATs) of types other than NR, and these base stations can be connected to CNs of other types. Further, in some implementations, the UE 102 also has direct access via a radio interface to other types of access networks, such as a wireless local area network (WLAN) 112 (via an access point (AP) 114, for example).

The base station 104 is associated with a RAN 108 and provides coverage to a cell 116. While FIG. 1 depicts the base station 104 as associated with only one cell 116, it is understood that the base station 104 in some implementations also covers one or more additional cells not shown in FIG. 1. Further, the RAN 108 can include any suitable number of base stations that collectively support one or more RATs. The UE 102 can communicatively connect with the RAN 108 via base station 104 when operating within cell 116, and in turn can communicatively connect with the CN 110 via the RAN 108.

The UE 102 is equipped with processing hardware 130, which can include one or more general-purpose processors (e.g., CPUs) and at least one non-transitory computer-readable memory 132 storing instructions executable on the one or more general processors and/or special-purpose processing units. The memory 132 stores an operating system (OS) 140 of the UE 102, which can be any type of suitable mobile or general-purpose operating system. In addition, in some implementations, the memory 132 also stores one or more applications 142. In operation, the one or more applications 142 generate outgoing traffic and receive incoming traffic. These applications can include web browsers, mailing applications, messaging applications, video and audio players, gaming applications, etc.

To communicate with the base station 104, the CN 110, and various remote hosts, the UE 102 implements a communication protocol stack that includes an upper layer 136 and an NAS/URSP handling layer 134. The layers 134 and 136 can be implemented using any suitable combination of hardware, software, and firmware. In one example implementation, the layers 134 and 136 are a set of instructions that the processing hardware 130 executes to perform the rule application techniques discussed herein.

The upper layer 136 can identify outgoing traffic at the UE and provide outgoing traffic to the NAS/URSP handling layer 134 for routing. The NAS/URSP handling layer 134 can be a combined layer including both a NAS layer and a URSP handling layer. The NAS layer can manage the establishment and maintenance of communication sessions, such as protocol data unit (PDU) sessions. Further, the NAS layer can receive URSP rules from the CN 110 and configure the URSP handling layer with the received URSP rules. The combined NAS/URSP handling layer 134 can manage the application of rules for routing outgoing traffic at the UE 102, as described in further detail below. When the upper layer 136 determines that an application 142 executing on the UE 102 has queued outgoing data for transmission, the upper layer 136 can direct the NAS/URSP handling layer 134 to apply one or more URSP rules and route the outgoing application traffic accordingly.

The NAS/URSP handling layer 134 in an example implementation includes a UE rule controller 138 configured to manage or control application of rules for routing outgoing traffic and prevent application of proscribed traffic descriptors.

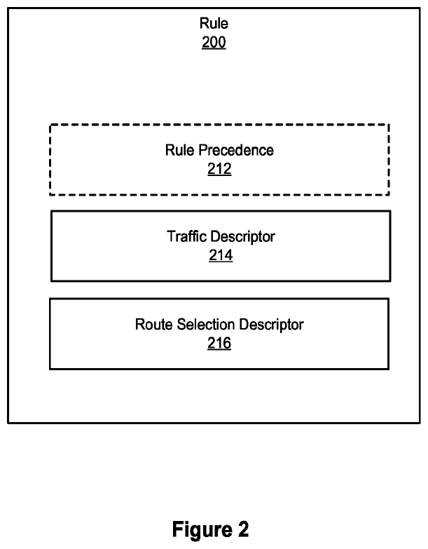

The CN 110 can be, for example, a 5G core network (5GC), a less advanced core network (e.g., an evolved packet core (EPC)) or, conversely, a more advanced core network. The CN 110 in some implementations is equipped with a mobility management entity such as Access and Mobility Management Function (AMF) 122 configured to manage authentication, registration, mobility, and other related functions, and a policy control entity such as Policy Control Function (PCF) 124 for providing policies for mobility and session management. The CN 110 also, in some implementations, includes a CN rule controller 128 configured to manage, modify, and transmit to the UE 102 (and other UEs) various rules for routing outgoing traffic at the UE 102, such as a set of rules associated with an URSP. The CN rule controller 128 can operate as a separate entity or as a component of the PCF 124, depending on the implementation. Depending on the implementation, the CN 110 additionally or alternatively includes a user plane function (UPF) 162, a unified data manager (UDM) 164, and/or a session management function (SMF) 166. The UPF 162 is generally configured to transfer user-plane packets related to audio calls, video calls, Internet traffic, etc., the UDM 164 is generally configured to manage network user data, and the SMF 166 is generally configured to manage PDU sessions. In some scenarios, the PCF 124 provides to the UE 102 a policy in accordance with which the UE 102 should route outgoing traffic. This policy can be including a set of rules that conform to the URSP, discussed in more detail below with reference to FIG. 2.

With continued reference to FIG. 1, the CN 110 communicatively connects UE 102, via the RAN 108 including the base station 104 (and typically multiple other base stations), to various communication networks including a wide area network such as the Internet 150. More specifically, the CN 110 can directly connect to a data network (DN) 168 via an access point name (APN) or data network name (DNN) gateway 152. The UE 102 can include outgoing traffic with a traffic descriptor that identifies the gateway 152, and the CN 110 can provide a rule that references the gateway 152. When the UE 102 determines that the traffic descriptor referencing the gateway 152 is permissible, the UE rule controller 138 applies the rule and routes the outgoing traffic in accordance with the rule. Otherwise, when the UE 102 determines that the traffic descriptor referencing the gateway 152 is proscribed, the UE rule controller 138 ignores the rule, modifies the rule, or otherwise processes the rule in accordance with the techniques of this disclosure. In other example scenarios, outgoing traffic and/or one or more rules can reference a domain 156, a particular host 154 (e.g., by host name or Internet Protocol (IP) address), type of traffic (e.g., Ethernet), etc.

FIG. 2 is a block diagram of an example rule 200 for route selection which the UE 102 of FIG. 1 can apply to outgoing traffic to determine how the UE 102 should route outgoing traffic. A route selection policy, such as a URSP received from CN 110 or a local configuration stored at the UE 102, includes one or more rules that conform to the format of FIG. 2. The example rule 200 includes a rule precedence 212, a traffic descriptor 214, and a route selection descriptor 216. In general, depending on the implementation rules include one or more traffic descriptors and one or more route selection descriptors.

The rule precedence field 212 specifies the order in which the UE 102 applies the rule 200 relative to other rules. In some implementations, the rule precedence 212 of each rule is different from the rule precedence of every other rule within the URSP. Traffic descriptors specify how the UE 102 should match outgoing traffic to the rule. For example, if the traffic descriptor 214 of rule 200 matches the parameters of outgoing traffic, then the UE 102 would apply rule 200 to the outgoing traffic. In some implementations, a URSP includes a rule with lowest precedence that has a “match all” traffic descriptor that UE 102 can apply to any outgoing traffic.

Traffic descriptors include, for example, application identifiers of applications 142 executing on the OS 140 of the UE 102. As another example, traffic descriptors also correspond to IP descriptors such as an IP destination and/or an IP 3 tuple including destination IP address or IPv6 network, port number, and protocol ID. In some implementations, traffic descriptors are also non-IP descriptors such as descriptors for Ethernet traffic. In some implementations, a traffic descriptor refers to a specific type of network traffic. Further, as discussed above, traffic descriptors in some implementations correspond to an APN or DNN gateway 152. In further implementations, traffic descriptors also correspond to various connection capabilities of the UE 102, such as IP Multimedia Subsystem (IMS) capabilities, Multimedia Message Service (MMS) capabilities, or other internet-related capabilities. In still further implementations, traffic descriptors are domain descriptors such as a domain name (e.g., of domain 156), a hostname (e.g., of host 154), or a fully qualified domain name (FQDN) made up of a domain name and a hostname.

The route selection descriptor 214 specifies how the UE 102 should route the traffic if the rule applies. In some examples, the route selection descriptor 216 specifies that the UE 102 should route traffic matching the traffic descriptor 214 of the rule 200 to an already-established communication session, such as an established Protocol Data Unit (PDU) session. As another example, the route selection descriptor 216 instructs the UE 102 to establish a new PDU session for outgoing traffic matching the rule 200. As yet another example, the route selection descriptor 216 instructs the UE 102 to offload outgoing traffic matching the rule 200 to a wireless local area network (WLAN) such as a Wi-Fi network.

In an example scenario, a URSP includes three rules. In some implementations, rule R₁ has a rule precedence of 1 and a traffic descriptor corresponding to application identifier App₁. In further implementations, rule R₂ has a rule precedence of 2 and traffic descriptor corresponding to application identifier App₂. In still further implementations, rule R₃ has a rule precedence of 3 and traffic descriptor corresponding to the “match all” option. When the UE 102 has outgoing traffic, the UE 102 evaluates the rules in the order of rule precedence. Thus, the UE 102 in this scenario first determines whether it should apply rule R₁ to the outgoing traffic by determining whether the outgoing traffic matches the traffic descriptor of rule R₁ (i.e., if the outgoing traffic corresponds to traffic of App₁). If the outgoing traffic corresponds to traffic of App₁, the UE 102 applies rule R₁ to the outgoing traffic and routes the traffic in accordance with the one or more route selection descriptors of rule App₁. If the outgoing traffic does not match the traffic descriptor of rule R₁, the UE 102 determines whether it should apply rule R₂, and so on.

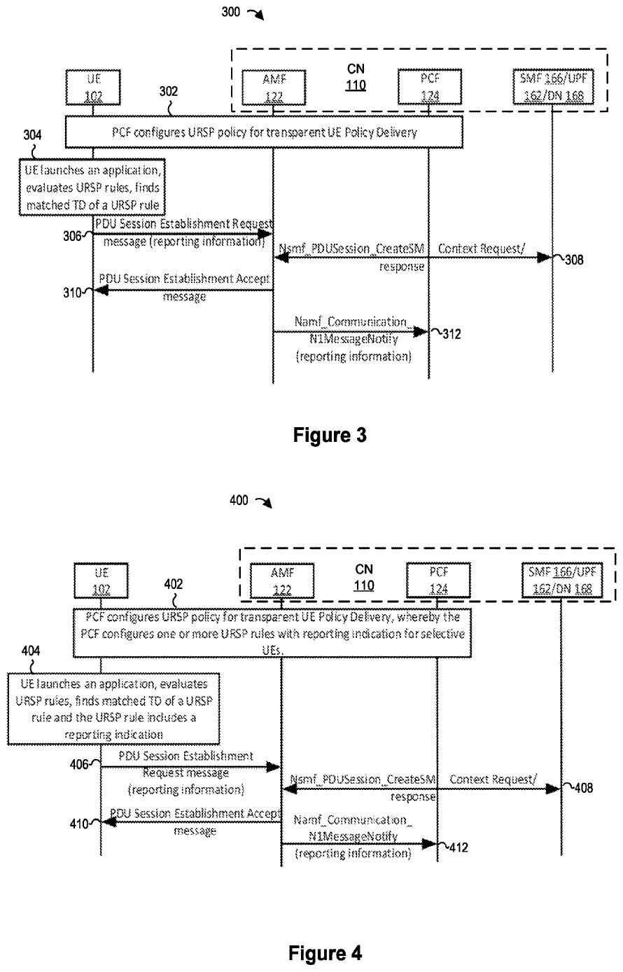

Next, FIG. 3 illustrates an example scenario 300 for reporting traffic categories for an enforced UE route selection policy to a CN 110. Depending on the implementation, the CN 110 includes an AMF 122, a PCF 124, and/or an SMF 166/UPF 162/DN 168. In some implementations, the CN 110 further communicates, directly or indirectly, with a UE 102.

The UE 102 reports the traffic categories for the enforced URSP rule as reporting information when the traffic categories are matched. Initially, the PCF 124 configures 302 URSP policy rule(s) for transparent UE policy delivery (e.g., based on 3GPP TS 23.502 clause 4.2.4.3 and FIG. 4.2.4.3-1 UE Configuration Update (UCU) procedure for transparent UE Policy delivery). The UE 102 then evaluates 304 the URSP rules. Depending on the implementation, a user launches an application (e.g., application 142) and the UE 102 evaluates the URSP rules to find a TD that matches the application descriptor. The UE 102 then applies the RSD as described herein. Depending on the implementation, the TD and/or application descriptor include traffic categories (e.g., based on GSMA recommendations). In some implementations, the traffic categories which are shared by different applications traffic are standardized traffic categories and/or operator specific traffic categories. In some implementations, the operator specific traffic categories include any of: IMS traffic, internet traffic, IoT and machine to machine type of traffic, on demand downlink streaming, on demand uplink streaming, vehicular communications, real time interactive traffic, unified communications traffic, background traffic, location-based traffic, and/or critical communications.

In some implementations, the traffic categories are represented by traffic descriptor(s) using at least one of the following two options.

In some implementations, as a first option, the TD includes a new traffic descriptor component, whereby a traffic categories component is encoded as a sequence of one octet traffic descriptor component type identifier and a traffic descriptor component value field. For example, a TD includes either: 1) a match-all traffic descriptor; or 2) at least one of the following components: A) one or more application identifiers (aka application descriptors); B) one or more IP 3 tuples (aka IP descriptor) (e.g., as defined in 3GPP TS 23.503), such as the destination IP address, the destination port number, and the protocol in use above the IP; C) one or more non-IP descriptors (i.e., destination information of non-IP traffic); D) one or more DNNs; E) one or more connection capabilities; and F) one or more domain descriptors (i.e., destination FQDN(s) or a regular expression as a domain name matching criteria); and/or G) one or more traffic categories.

In some implementations, as a second option, the TD uses an existing traffic descriptor component with an extended traffic descriptor component value field for traffic categories, whereby the traffic categories are used to accommodate connectivity requirements that are provided in existing traffic descriptor component (i.e., a Connection Capabilities component). For example, the operator specific traffic categories are included as operator specific connection capabilities. That is, for a connection capabilities component type, the component value field is extended to indicate operator specific traffic categories.

For a “connection capabilities” type, the traffic descriptor component value field is encoded as a sequence of one octet per number of network capabilities followed by one or more octets, each containing a connection capability identifier encoded as depicted below.

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | IMS |
| 0 | 0 | 0 | 0 | 0 | 0 | 1 | 0 | MMS |
| 0 | 0 | 0 | 0 | 0 | 1 | 0 | 0 | SUPL |
| 0 | 0 | 0 | 0 | 1 | 0 | 0 | 0 | Internet |
| 0 | 0 | 1 | 0 | 0 | 0 | 0 | 0 | Operator specific |
| to | | | | | | | | connection |
| 0 | 0 | 1 | 1 | 1 | 1 | 1 | 1 | capabilities |

In some examples, the connection capability component values are extended to accommodate new traffic categories for future proofing (e.g., the value field is extended from 1 byte to more than 1 bytes, such as 2-3 bytes).

The UE 102 then transmits 306 a message to the AMF 122, including reporting information. Depending on the implementation, the message that the UE 102 transmits includes a PDU session establishment request message, an UL NAS transport message, etc. In further implementations, the reporting information additionally includes a number of applications within traffic categories that are using the enforced URSP rule. For example, when an application-A (app-A) is first launched based on an enforced URSP rule, the UE 102 reports the matched traffic categories and number of applications as 1 within the traffic categories that apply the enforced URSP rule in the PDU session establishment procedure.

As another example, when an application-B (app-B) is launched using the same enforced URSP rule as app-A after a first launched app-A, the UE 102 reports the matched traffic categories and number of applications as 2 within the traffic categories that apply the same enforced URSP rule in the PDU session modification procedure. As yet another example, when an app-B and application-C (app-C) are launched using the same enforced URSP rule as app-A after a first launched app-A without initiating a PDU session modification procedure, the UE 102 reports traffic categories and number of applications as 3 within the traffic categories that apply the same enforced URSP rule in the UL NAS Transport message when the allocated periodic UE reporting timer is expired.

Depending on the implementation, the UE 102 transmits 306 the reporting information in any of the following situations: (1) a new IE in the PDU Session establishment request message; (2) a new IE in the PDU Session modification request message; (3) a new container for UE reporting in the UL NAS Transport Message (AMF); (4) a new NAS Session Management message for reporting sent to SMF via AMF; and/or (5) a new payload IE or IE for UE reporting information in the registration request message and a new registration type for UE reporting enforced URSP rules.

In some implementations, for at least situation (3) above, the UE 102 reports an enforced URSP rule in the UL NAS Transport Message periodically if a new IE (e.g., a periodic UE reporting timer) is allocated by the AMF 162 in the Registration Accept message during a registration request procedure. In some implementations, the UE 102 reports when the message includes a registration type indicated as initial registration or mobility update.

In some implementations, for at least situation (4), the UE 102 reports enforced URSP rule(s) as an indication included in a new NAS Session Management message sent to the SMF 166 via AMF 122. The UE 102 sends the new NAS Session management message including information regarding the currently enforced URSP rules that are applied in different PDU sessions, whereby, in some implementations, the information is or includes be traffic categories, or at least one of Application ID(s), URSP rule ID(s) (instead of the PDU Session establishment/modification request message), etc.

In some implementations, for at least situation (5), the UE reporting for the enforced URSP rule(s) is included in a registration message with new registration type of “UE reporting”. The UE 102 sends the registration request message including reporting information in a new payload IE for the currently enforced URSP rule(s) that are applied in different PDU sessions, whereby, in some implementations, the reporting information includes traffic categories, or at least one of Application ID(s), URSP rule ID(s) (instead of the PDU Session establishment/modification request message), etc. When the AMF 122 receives the registration request message including the new payload and the registration type indicated as “UE reporting”, the AMF 122 sends it to the PCF 124.

Depending on the implementation, the UE 102 sends a PDU session establishment request message including UE reporting information of an enforced URSP rule (e.g., based on a PDU Session Establishment procedure (e.g., as described in clause 4.3.2. of TS 23.503)). In particular, the UE 102 transmits 306 the reporting information to the CN 110 in an UL NAS transport message according to various different techniques. In a first example, the UE 102 transmits 306 the reporting information in a new container type to transmit the corresponding container to the PCF 124 via the AMF 122. In another example, the UE 102 transmits 306 the reporting information in a new container type to transmit the corresponding container to the SMF 166 via the AMF 122. In still another example, the UE 102 transmits 306 the reporting information in an existing UE policy container type to transmit the corresponding container to the PCF 124 via the AMF 122.

The AMF 122 and the SMF 166/UPF 162/DN 168 then exchange 308 messages to establish the PDU Session (e.g., an Nsmf_PDUSession_CreateSMContext request and/or response message). After exchanging 308 messages, the AMF 122 then transmits 310 a PDU Session Establishment Accept message to the UE 102 and/or transmits 312 a notification to the PCF 124 including the reporting information received from the UE 102. In some implementations, the AMF 122 transmits 312 the reporting information in an Namf_Communication_N1MessageNotify message or any other similar message to the PCF 124.

As an example of the techniques illustrated in FIG. 3, take app-A and app-B belonging to the background traffic of an operator specific traffic category. A URSP rule-A includes the traffic category of the background traffic as (1) the traffic descriptor component or (2) an existing connection capabilities component. In such an example, the UE 102 receives URSP policy including URSP rule-A. Then, when the UE 102 launches the app-A, the UE 102 finds a match for the traffic descriptor of the URSP rule-A. The UE 102 initiates the PDU session establishment request procedure including a PDU session ID-A and parameters specified in RSD based on the enforced URSP rule-A. The UE 102 also indicates reporting information of traffic categories for UE reporting of the enforced URSP rule-A.

In some implementations, the reporting information includes the traffic categories component, which in turn includes an operator specific traffic categories component type identifier and/or a component value field indicated as the background traffic. In further implementations, the reporting information includes the connection capabilities component, which in turn includes traffic categories information as follows: a connection capabilities component type identifier and/or a connection capabilities component value field indicated as the background traffic, which is for operator specific traffic categories.

Alternatively, the UE 102 launches an app-B and the UE 102 determines to use the existing PDU session with PDU session ID-A for the app-B based on URSP rule-A. If the app-B has different QoS requirements, the UE 102 applies the URSP rule-A and initiates a PDU session modification request procedure with the same PDU session ID-A, using the requested QoS requirements, and indicates reporting information.

In some implementations the reporting information includes the traffic categories component, which in turn includes an operator specific traffic categories component type identifier and/or a component value field indicated as the background traffic. In other implementations, the reporting information includes a connection capabilities component, which includes traffic categories information as follows: a connection capabilities component type identifier and/or a connection capabilities component value field indicated as the background traffic, which is for operator specific traffic categories. In further implementations, the UE 102 additionally indicates the number of applications for the matched traffic categories (e.g., 2 in the above example with app-A and app-B).

In implementations in which the app-B has the same QoS requirement(s), the UE 102 applies the URSP rule-A without having to initiates the PDU session modification request procedure for reporting the information of the enforced URSP rule. In alternative implementations, the UE 102 reports the matched traffic categories and number of applications as 2 for the enforced URSP rule in the PDU session modification procedure.

In still alternative examples, when the app-A has different QoS requirement(s), the UE 102 initiates a PDU session modification request procedure for PDU session-A with the requested QoS requirements for app-A. The UE 102 applies the URSP rule-A without having to report the information of the enforced URSP rule in the PDU session modification procedure. Alternatively, the UE 102 reports the matched traffic categories and number of applications as 1 for the enforced URSP rule in the PDU session modification procedure.

In at least some of the above examples, the user privacy is preserved by indicating only operator specific traffic categories of the enforced URSP rule. In the meantime, there is no PDU session modification request procedure triggered for the purpose of reporting the enforced URSP rule. As such, depending on the implementation, signaling overhead is reduced while maintaining user privacy.

In some implementations, compared to other systems, where the UE 102 reports the application ID or URSP rule ID (as reporting information) of the enforced URSP rule, the UE 102 reports the application ID/URSP rule ID for any PDU session modification procedures, which are incurred by the new launched applications or existing applications. In further implementations, the UE 102 reports the application ID/URSP rule ID for any PDU session modification procedures, which are incurred by the changes of QoS requirements requested by the existing applications (which, in turn, already report the enforced URSP rule during the PDU session establishment procedure).

In further examples, the URSP rule(s) include multiple TD components of the same TD component type. In some such examples, the UE 102 reports the “matched TD component(s)” for the enforced URSP rule when there include multiple TD components of the same TD component type. In some implementations, the TD component type includes an operator specific traffic categories component type. In further implementations, the TD component type includes a connection capabilities component type (with values for operator specific traffic categories).

If the traffic descriptor contains more than one traffic descriptor component of the same traffic descriptor component type as “traffic categories” or “connection capabilities”, at least one of the traffic categories (component value field) of the same traffic descriptor component type are to be matched with the application information. In some implementations, for UE reporting of enforced URSP rules, the UE 102 reports the information according to various techniques. In some implementations, the UE 102 reports the matched traffic categories components (traffic categories component type ID and traffic categories component values) for the enforced URSP rule. In further implementations, the UE 102 reports the matched traffic categories for the enforced URSP rule. Depending on the implementation, the matched traffic categories include matched connection capabilities components, one connection capability component type ID and matched connection capability component values, and/or matched connection capabilities components values.

Depending on the implementation, if the traffic descriptor contains more than one traffic descriptor component of the same traffic descriptor component type, at least one of the traffic descriptor components of the same traffic descriptor component type shall be matched with the application information.

In another example, the traffic descriptor contains more than one traffic descriptor component type. In some such examples, the UE 102 reports the matched traffic categories of the enforced URSP rule when one or more traffic categories and at least one of the following components are matched. Depending on the implementation, the components include any or all of: (A) one or more application identifiers (aka application descriptors); (B) one or more IP 3 tuples (aka IP descriptor) (i.e., the destination IP address, the destination port number, and the protocol in use above the IP); (C) one or more non-IP descriptors (i.e., destination information of non-IP traffic); (D) one or more DNNs; (E) one or more connection capabilities; and/or (F) one or more domain descriptors (i.e., destination FQDN(s) or a regular expression as a domain name matching criteria).

If the traffic descriptor contains more than one traffic descriptor component of different traffic descriptor component types, and one of the traffic descriptor component types is related to traffic categories (e.g., “traffic categories” or “connection capabilities”), all of components shall be matched. In some implementations, for UE reporting information of enforced URSP rules, the UE 102 reports according to a variety of techniques. In some implementations, the UE 102 reports the matched traffic categories components (traffic categories component type ID and traffic categories component values) of the enforced URSP rule. In other implementations, the UE 102 reports the matched connection capabilities component of the enforced URSP rules. As an example, the UE 102 reports matched connection capabilities components, one connection capability component type ID and matched connection capability component values, and/or matched connection capabilities components values.

If a traffic descriptor lists one or more application identifiers together with one or more connection capabilities, the UE 102 shall consider that the application identifiers identify the applications requesting access to the connection capabilities. If the traffic descriptor contains more than one traffic descriptor component type, each of a different type, each traffic descriptor component type shall be matched.

FIG. 4 illustrates an example scenario 400 similar to the scenario 300 illustrated in FIG. 3. In the scenario 400, the UE 102 reports to the CN 110 when the enforced URSP rule includes a reporting indication. The PCF 124 configures 402 URSP policy for transparent UE policy delivery as described previously with reference to FIG. 3 element 302. The UE 102 evaluates 404 the URSP rule that the PCF 124 configures 402 and determines that the URSP rule includes a reporting indication in the URSP rule. Based on the reporting indication in the URSP rule, the UE 102 applies the RSD and reports to the network if the URSP rule including a reporting indication is enforced by the UE 102.

For example, the PCF 124 provides two URSP rules to the UE 102, including URSP rule A and URSP rule B, whereby the URSP rule A contains a reporting indication, and URSP rule B does not contain a reporting indication. In such examples, if the UE 102 enforces URSP rule A, the UE indicates reporting information in the PDU session establishment/modification request. However, in some implementations, if the UE 102 enforces URSP rule B, which does not include the reporting indication, the UE 102 does not indicate reporting information in the PDU session establishment/modification request. Depending on the implementation, the PCF 124 configures the URSP rule(s) to include a reporting indication using a variety of further techniques. In some examples, the reporting indication is an optional indication. As such, if the reporting indication is not included in the URSP rule, the UE 102 does not need to send reporting information. Alternatively, the reporting indication is an active or inactive indicator, which can be enabled or disabled. As another alternative, the reporting indication is a random number as a reporting threshold (e.g., 0.8). When the UE 102 generates a random number larger than the reporting threshold, the UE 102 transmits the reporting information for the enforced URSP rule.

The UE 102 then transmits 406 the reporting information to the AMF 122. Depending on the implementation, the UE 102 transmits 406 the reporting information in a PDU session establishment request message or a similar such message to the AMF 122. The AMF 122 then exchanges 408 context messages with the SMF 166/UPF 162/DN 168 (e.g., in an Nsmf_PDUSession_CreateSMContext request and response exchange). The AMF 122 then transmits 410 a session establishment accept message (e.g., a PDU Session Establishment Accept message) to the UE 102 and/or transmits 412 a notification to the PCF 124 (e.g., an Namf_Communication_N1MessageNotify message) including the reporting information. Elements 406, 408, 410, and 412 are similar to their FIG. 3 counterparts 306, 308, 310, and 312.

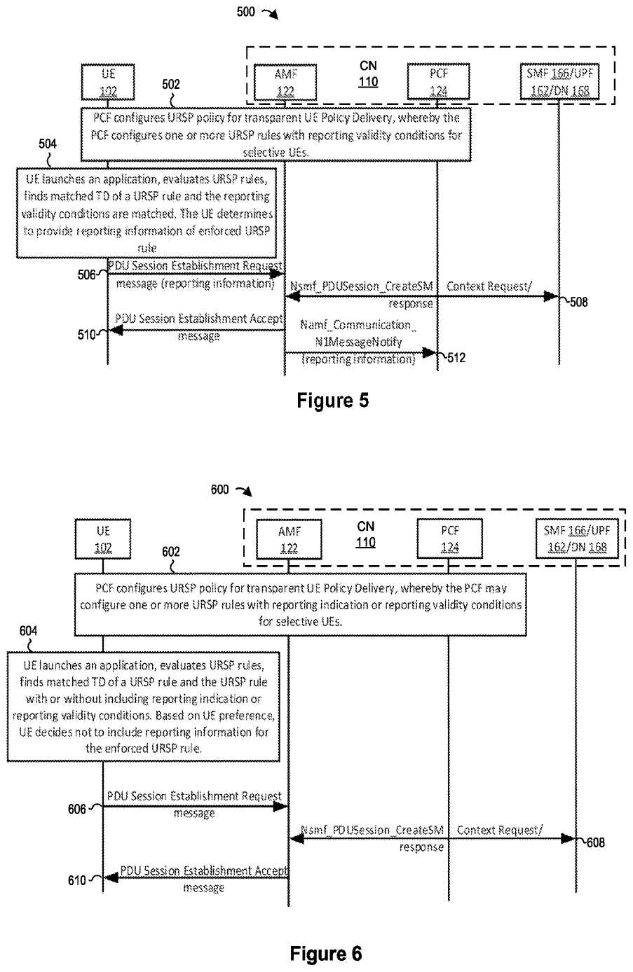

FIG. 5 illustrates an example scenario 500 similar to the scenario 300 illustrated in FIG. 3. In the scenario 500, the UE 102 reports to the CN 110 when the UE 102 fulfills reporting validity conditions included in the enforced URSP rule. In particular, when the PCF 124 configures 502 the URSP rule(s), the PCF 124 configures 502 the URSP rule(s) to include UE reporting validity conditions, which, depending on the implementation, includes any or all of the following: location (e.g., 3GPP location: TA (tracking area), CID (cell identifier)); time; one or more TD component(s), TD component type(s), or TD component value(s) of the enforced URSP rule; one or more RSD component(s), RSD component type(s), or RSD component value(s) of the enforced URSP rule.

Depending on the implementation, the PCF 124 configures 502 the URSP rule to include reporting validity conditions according to a number of various techniques. In some implementations, the PCF 124 adds the reporting validity condition(s) as a new reporting descriptor or IE in the URSP rule. In other implementations, the PCF 124 adds the reporting validity condition(s) as a new IE in the RSD (e.g., where the validity condition includes only RSD related info). In still other implementations, the PCF 124 adds the reporting validity condition(s) as a new IE in TD (e.g., where the validity condition includes only TD related info).

In some such implementations, then, a URSP rule includes: (a) a precedence value of the URSP rule identifying the precedence of the URSP rule among all the existing URSP rules; (b) a traffic descriptor (TD), including either: (1) a match-all traffic descriptor; or (2) at least one of the following components: (A) one or more application identifiers; (B) one or more IP 3 tuples (i.e., the destination IP address, the destination port number, and the protocol in use above the IP); (C) one or more non-IP descriptors (i.e., destination information of non-IP traffic); (D) one or more DNNs; (E) one or more connection capabilities; and (F) one or more domain descriptors (i.e., destination FQDN(s) or a regular expression as a domain name matching criteria); and (3) validity conditions (e.g., location, time, and TD component(s)); (c) one or more route selection descriptors (RSD), each consisting of a precedence value of the route selection descriptor and either: (1) one PDU session type and, optionally, one or more of the following: (A) SSC mode; (B) one or more S-NSSAIs; (C) one or more DNNs; (D) Void; (E) preferred access type; (F) multi-access preference; (G) a time window; (H) location criteria; (I) PDU session pair ID; and (J) RSN; (2) non-seamless, non-3GPP offload indication; or (3) 5G ProSe layer-3 UE-to-network relay offload indication. Depending on the implementation, the URSP also includes (4) RSD validity conditions (e.g., location, time, and RSD component(s)); and/or (d) a new IE or reporting descriptor for validity condition. Depending on the implementation, if the URSP rule is a part of a non-subscribed SNPN signaled URSP, the S-NSSAI is of the non-subscribed SNPN. Otherwise, the S-NSSAI is of the HPLMN or the subscribed SNPN. In some implementations, a mapped HPLMN SST and mapped HPLMN SD are not included in the S-NSSAI.

If a URSP rule is enforced and the UE reporting descriptor is matched, the UE indicates the reporting information for the enforced URSP rule in the PDU session establishment and PDU session modification procedures.

The UE 102 transmits 506 the reporting information to the AMF 122 in response to evaluating 504 the URSP rule and determining that the validity conditions are fulfilled. Depending on the implementation, the UE 102 transmits the reporting information in a session establishment request (e.g., a PDU Session Establishment Request) and/or any other similar message. In some implementations, the reporting information is or includes a traffic category as described above with regard to FIG. 3. In further implementations, the reporting information is or includes an application identifier and/or application descriptor.

If the URSP rule includes an application descriptor in the TD (see 3GPP TS 23.503, clause 6.6.2.1), and the URSP rule is matched based on the application descriptor, the UE 102 reports the application descriptor via the PDU Session Establishment or Modification (i.e., when the URSP rule is matched), then to the AMF 122 and/or PCF 124 for the PDU Session and to the PCF 124 for the UE 102. In further implementations, the UE 102 does not report information to the CN 110 when a “match-all” URSP rule is enforced.

Depending on the implementation, the reporting information is or includes a URSP Rule ID. In some implementations, if a new identifier (e.g., the URSP Rule ID) is incorporated into each of the URSP rules as the identifier for a URSP rule, the UE 102 reports the URSP rule ID of the enforced URSP rule to the network when the URSP rule is matched and the UE 102 applied it (e.g., in the PDU Session establishment or modification message). In some implementations, the UE 102 does not report information to the CN 110 when a “match-all” URSP rule is enforced.

The AMF 122 then exchanges 508 context messages with the SMF 166/UPF 162/DN 168 (e.g., in an Nsmf_PDUSession_CreateSMContext request and response exchange). The AMF 122 then transmits 510 a session establishment accept message (e.g., a PDU Session Establishment Accept message) to the UE 102 and/or transmits 512 a notification to the PCF 124 (e.g., an Namf_Communication_N1MessageNotify message) including the reporting information. Elements 506, 508, 510, and 512 are similar to their FIG. 3 counterparts 306, 308, 310, and 312.

FIG. 6 illustrates an example scenario 600 similar to the scenario 300 illustrated in FIG. 3. In the scenario 600, the UE 102 reports to the CN 110 when the UE 102 indicates a preference for reporting to the CN 110. In particular, the UE preference takes precedence for the UE reporting of enforced URSP rule in at least the following cases: (1) if the UE preference does not enable the UE 102 to report the enforced URSP rule, the UE 102 does not report the application ID, URSP rule ID, traffic categories, etc. for the enforced URSP rule as described herein, and (2) if the UE preference does not enable the UE 102 to report the enforced URSP rule and the enforced URSP rule includes a reporting indication or reporting descriptor, the UE 102 does not report the application ID, URSP rule ID, traffic categories, etc. for the enforced URSP rule as described herein.

Depending on the implementation, the UE preference of UE reporting for an enforced URSP rule is further indicated in more granularity by the UE 102. For example, in some implementations, the UE preferences are subject to different traffic categories. In further implementations, the UE preferences are subject to different application identifiers.

As such, the PCF 124 configures 602 the URSP rule(s) and the UE 102 evaluates 604 the URSP rule(s) as described above with regard to FIGS. 3-5. However, the UE 102 further determines whether the UE preference instructs the UE 102 to include reporting information or not and ultimately gives precedence to the UE preference. In the example scenario 600, the UE preference indicates not to include reporting information, so the UE 102 transmits 606 a PDU session establishment request without any reporting information. Similarly, the AMF 122 exchanges 608 context messages with the SMF 166/UPF 162/DN 168 before transmitting 610 a PDU session establishment accept message to the UE 102, as described above. In some implementations, the UE preference includes an indication of user consent for reporting by the UE 102, which resolves user privacy concerns otherwise inherent to reporting.

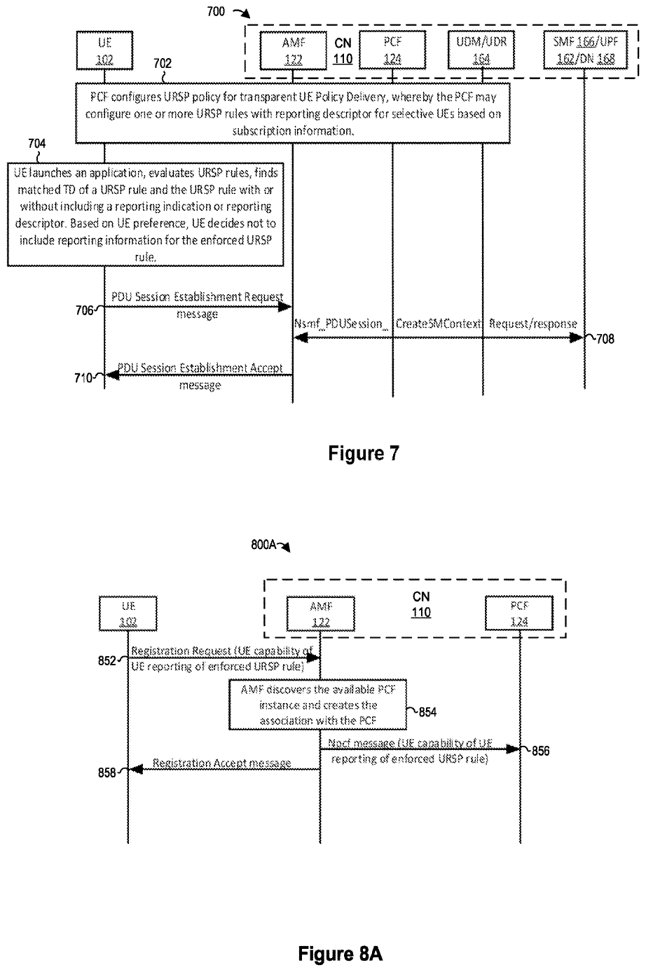

FIG. 7 illustrates an example scenario 700 similar to the scenario 300 illustrated in FIG. 3. In the scenario 700, the PCF 124 configures URSP rule(s) with a reporting indication or descriptor (as described above with regard to FIGS. 4 and 5, respectively) based on subscription information from the UE 102. In particular, the PCF 124 configures 702 URSP rules to include a reporting indication or reporting descriptor when UE subscription information indicates that reporting is supported, preferred, allowed, etc. for the UE 102.

In some implementations, the subscription information is stored in the UDM or UDR 164. Depending on the implementation, the subscription information is or includes one or more of the following: user consent (e.g., for the UE 102 to report enforced URSP rule(s)); subscribed S-NSSAI(s), which includes network slices to which the UE 102 subscribes (in some roaming cases, the UE 102 indicates the subscribed network slices applicable to the serving PLMN); and/or a subscribed DNN list, which includes a list of the subscribed DNNs for the UE 102 and is used to determine a list of Local Area Data Networks (LADNs) available to the UE 102.

In some examples, the user consent checking is performed to ensure that the PCF 124 only requests UE reporting for enforced URSP rule from the UEs 102 which have user consent for UE reporting for enforced URSP rule (e.g., UEs 102 for which consent is stored in a UE subscription). In further examples, the PCF 124 requests a UE 102 to report for an enforced URSP rule only if the UE 102 has specific subscribed S-NSSAI(s) that are included in the RSD(s) of the URSP rule. As another example, the PCF 124 requests a UE 102 to report for an enforced URSP rule only if the UE 102 has specific subscribed DNN(s) that are included in RSD(s) of the URSP rule.

In the example of scenario 700, events 704, 706, 708, and 710 occur similarly to events 604, 606, 608, and 610, respectively.

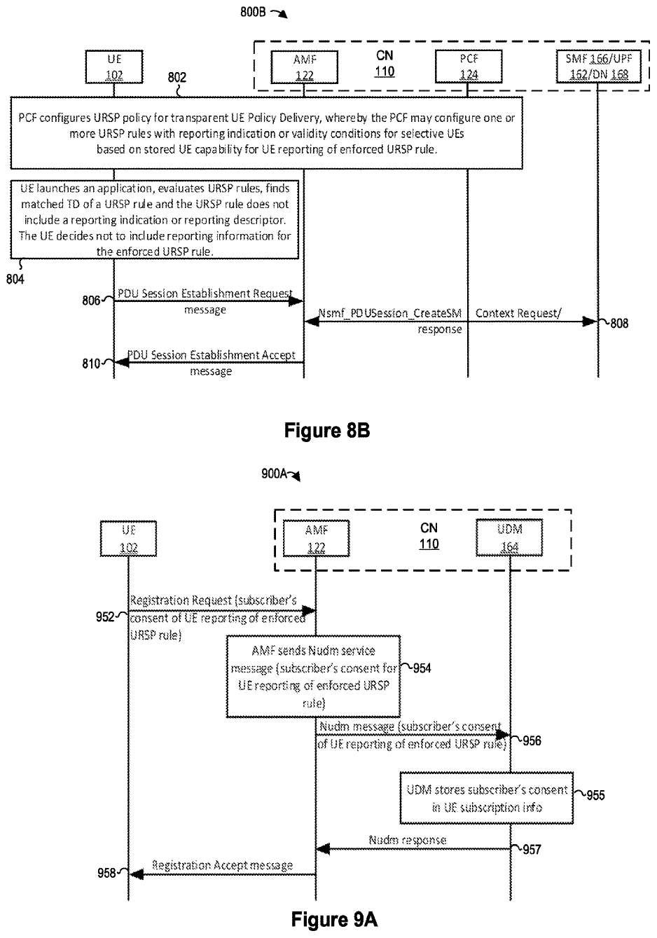

FIG. 8A illustrates an example scenario 800A, in which the UE 102 transmits a registration request including UE reporting capabilities to the CN 110. In particular, the PCF 124 configures the URSP rules based on stored information related to the reporting capability of the UE 102 to report information for an enforced URSP rule. The UE 102 transmits an indication of the capability of the UE 102 for reporting information for an enforced URSP rule during a registration procedure.

The UE 102 initially transmits 852 a registration request message to the AMF 122 in a CN 110. In some implementations, the registration request message includes URSP feature support (e.g., features in the extended 5GSM capability) for the UE 102 to indicate support for UE reporting of an enforced URSP rule.

When the AMF 122 in the CN 110 receives 852 the registration request message (e.g., with a UE policy container IE, the payload container type IE set to UE policy container, and extended 5GSM capability for URSP feature support with UE reporting information of an enforced URSP rule), the AMF 122 discovers 854 a PCF instance from NRF and creates a PCF association for the UE 102. The AMF 122 then forwards 856 UE reporting information for an enforced URSP rule to the associated PCF 124 for the UE 102 (e.g., in an Npcf message). The AMF 122 also responds 858 to the UE 102 with a registration accept message.

The PCF 124 stores the information regarding the UE capability for reporting of an enforced URSP rule, and accesses the information when configuring the URSP policy for the UE 102.

When the PCF determines to provision or update the UE policy related to URSP policy based on UCU procedure (e.g., as described in 3GPP TS 23.502 clause 4.2.4.3), the PCF configures the URSP rules in URSP policy for delivery of the UE policy to the UE based on the stored information related to capability of UE reporting information for enforced URSP rule. In some implementations, if the UE capability for reporting information for an enforced URSP rule is indicated as supported, at least one of the following solutions is applied: (1) the UE 102 indicates an application identifier and/or application descriptor, or a URSP rule ID in the PDU session establishment or PDU session modification procedure(s) for the UE 102 to report an enforced URSP rule; (2) the UE 102 reports traffic categories; (3) the UE 102 reports traffic categories based on a reporting indication for the enforced URSP rule; (4) the UE 102 reports traffic categories based on a matched reporting descriptor for the enforced URSP rule; (5) if the UE 102 indicated support for the UE reporting information for an enforced URSP rule, the UE 102 considers UE preferences when determining whether to report information associated with the enforced URSP rule; and/or (6) if the UE 102 indicated support for the UE reporting information for an enforced URSP rule, the PCF 124 checks UE subscription information and determines the configuration for the URSP rules.

FIG. 8B illustrates an example scenario 800B similar to the scenario 700 illustrated in FIG. 7. In the scenario 800B, the PCF 124 of the CN 110 configures 802 the URSP rule(s) based on the reporting capabilities of the UE 102, as described with regard to FIG. 8A above. The system then performs events 804, 806, 808, and/or 810 similar to events 704, 706, 708, and/or 710, respectively, as described above with regard to FIG. 7.

In alternative implementations, the UE 102 transmits user consent for the UE 102 to report information for an enforced URSP rule in an UL NAS transport message. In some such implementations, the UL NAS transport message includes a new container type to allow the UE 102 to include subscriber's consent for the UE 102 to report information for an enforced URSP rule in the corresponding container to the AMF 122. With the new container type, the AMF 122 sends the reporting information to the PCF 124.

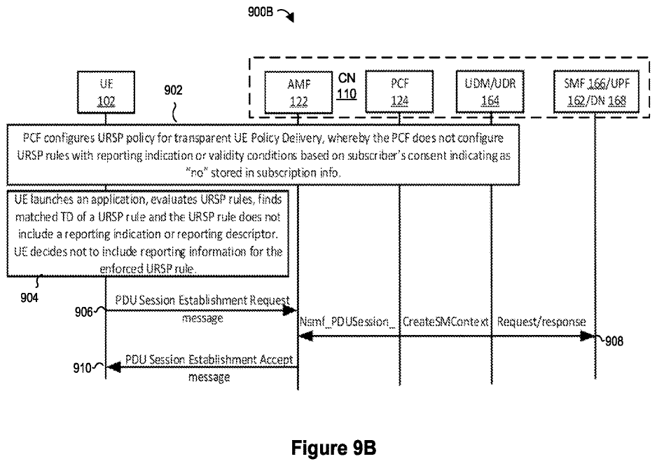

FIG. 9A illustrates an example scenario 900A similar to the scenario 800A illustrated in FIG. 8A. In scenario 900A, the UE 102 transmits a registration request message to the CN 110 that includes an indication of subscriber's consent for the UE 102 to report an enforced URSP rule.

In some implementations, the UE 102 transmits 952 a registration request message (e.g., an NAS message) to the AMF 124 in the CN 110, the registration request message including a new subscriber consent IE for the UE 102 to indicate subscriber's consent for the UE 102 to report information for an enforced URSP rule. When the AMF 124 in the CN 110 receives the registration request message with subscriber's consent for the UE 102 to report the enforced URSP rule, the AMF 122 sends 954 a service message (e.g., an Nudm message) to a UDM 164 indicating the subscriber's consent for the UE 102 to report information for an enforced URSP rule. In further implementations (not shown), the UE 102 additionally or alternatively transmits an uplink message (e.g., an UL NAS Transport message) including a new container type (e.g., a subscriber consent container) to allow the UE 102 to include an indication of subscriber consent for the UE 102 to report information regarding the enforced URSP rule(s) to the AMF 122. In some implementations, the AMF 122 sends 956 the container to the UDM 164.

After receiving 956 the service message, the UDM 164 stores 955 the subscriber's consent for the UE 102 to report the enforced URSP rule (e.g., in UE subscription information). The UDM 164 then responds 957 to the message from the AMF 122 (e.g., via an Nudm response message) and the AMF 122 in turn transmits 958 a registration accept message to the UE 102.

FIG. 9B illustrates an example scenario 900B similar to the scenario 700 illustrated in FIG. 7. In the scenario 900B, the PCF 124 of the CN 110 configures 902 the URSP rule(s) based on the subscriber consent for the UE 102 to report, as described with regard to FIG. 9A above.

In particular, when the PCF determines to provide or update the UE policy related to the URSP rule(s) (e.g., based on UCU procedure in 3GPP TS 23.502 clause 4.2.4.3), the PCF 124 configures 902 the URSP rules for delivery of the UE policy to the UE 102 based on the subscription information related to subscriber's consent for an enforced URSP rule. In some implementations, the PCF 124 configures 902 the URSP rule(s) for delivery to the UE 102 based on the stored information related to subscriber consent of UE reporting information for enforced URSP rule, whereby the subscriber consent of UE reporting information for enforced URSP rule is obtained by the network (e.g., in a NAS message).

In some implementations, if a subscriber's consent for the UE 102 to report the enforced URSP rule is indicated as supported, the UE 102 performs one or more techniques after evaluating 904 the URSP rule(s). Depending on the implementation, (1) the UE 102 indicates an “application identifier/application descriptor” or URSP rule ID in the PDU session establishment or PDU session modification procedures for the UE 102 to report the enforced URSP rule; (2) the UE 102 reports traffic categories; (3) the UE 102 reports traffic categories based on reporting indication of the enforced URSP rule; (4) the UE 102 reports traffic categories based on matched reporting validity conditions of the enforced URSP rule; (5) if the UE 102 indicated support for the UE 102 to report information for an enforced URSP rule, the UE 102 considers UE preferences when determining whether to perform UE reporting of the enforced URSP rule; and/or (6) if the UE 102 indicated support for the UE 102 to report information for an enforced URSP rule, the PCF 124 checks UE subscription information and determines the configuration of URSP rules.

The system then performs events 906, 908, and/or 910 similar to events 704, 706, 708, and/or 710, respectively, as described above with regard to FIG. 7.

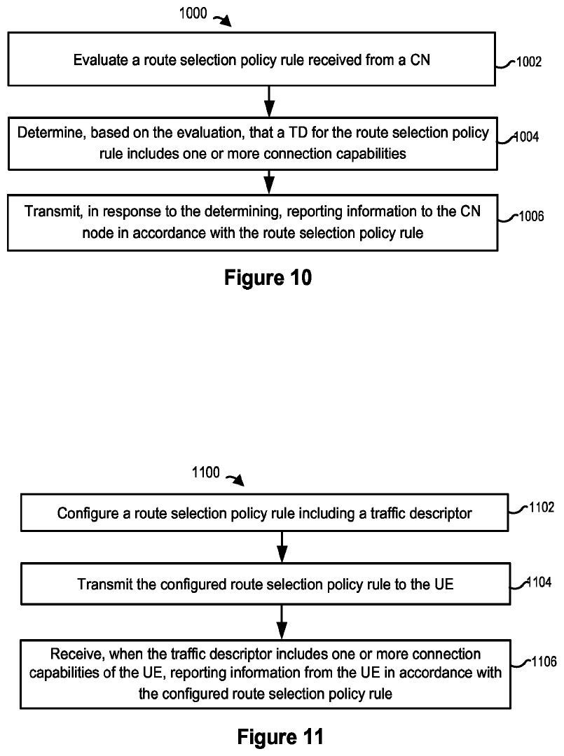

FIG. 10 illustrates a flow diagram of an example method 1000 for supporting a route selection policy in a UE (e.g., UE 102 of FIG. 1) running an application. At block 1002, the UE evaluates a route selection policy rule received from a CN node (e.g., CN 110 of FIG. 1 (e.g., including AMF 122, PCF 124, UDM/UDR 164, SMF 166, UPF 162, and/or DN 168)) (e.g., events 304, 404, 504, 604, 704, 804, and 904 of FIGS. 3-9B). At block 1004, the UE determines, based on the evaluation, that a traffic descriptor for the route selection policy rule includes one or more connection capabilities (e.g., as described with regard to FIG. 3 above). At block 1006, the UE transmits, in response to the determining, reporting information to the CN node in accordance with the route selection policy rule (e.g., events 306, 406, 506, 606, 706, 806, and 906 of FIGS. 3-9B).

FIG. 11 illustrates a flow diagram of an example method 1100 for supporting a route selection policy in a CN node (e.g., CN 110 (e.g., including AMF 122, PCF 124, UDM/UDR 164, SMF 166, UPF 162, and/or DN 168)) for a UE (e.g., UE 102 of FIG. 1) running an application. At block 1102, the CN node configures a route selection policy rule including a traffic descriptor (e.g., events 302, 402, 502, 602, 702, 802, and 902 of FIGS. 3-9B). In some implementations, the traffic descriptor includes (e.g., is configured to include) connection capabilities (e.g., events 402, 502, 602, 702, and 802 of FIGS. 4-8B, and as described with regard to FIG. 3). At block 1104, the CN node transmits the configured route selection policy rule to the UE (e.g., events 302, 402, 502, 602, 702, 802, and 902 of FIGS. 3-9B). At block 1106, the CN node receives reporting information from the UE in accordance with the configured route selection policy rule (e.g., events 306, 406, 506, 606, 706, 806, and 906 of FIGS. 3-9B). In some implementations, the CN node receives the reporting information when the traffic descriptor includes one or more connection capabilities of the UE (e.g., as described with regard to FIG. 3 above).

The following list of examples reflects a variety of the embodiments explicitly contemplated by the present disclosure:

Example 1. A method for managing reporting for a route selection policy for a user equipment (UE) running an application, the method implemented in the UE and comprising: evaluating, by processing hardware, a selection policy rule received from a core network (CN) node; determining, by the processing hardware and based on the evaluation of the selection policy rule, that a traffic descriptor for the route selection policy rule is associated with an application descriptor for the application; and transmitting, by the processing hardware and in response to the determining, reporting information to the CN node.

Example 2. The method of example 1, wherein the transmitting is based on a UE reporting preference indicating that the UE is to report.

Example 3. The method of example 2, wherein the UE reporting preference is a UE reporting preference for a particular traffic category.

Example 4. The method of example 2, wherein the UE reporting preference is a UE reporting preference for a particular application identifier.

Example 5. The method of any of the preceding examples, the method including: determining that a traffic category for the application matches a traffic category for the route selection policy rule; wherein the transmitting is responsive to determining that the traffic category for the application matches the traffic category for the route selection policy rule.

Example 6. The method of any of the preceding examples, wherein the traffic category is at least one of: (i) internet protocol (IP) multimedia subsystem (IMS) traffic, (ii) internet traffic, (iii) internet of things (IoT) or machine-to-machine traffic, (iv) on demand downlink streaming traffic, (v) on demand uplink streaming traffic, (vi) vehicular communication traffic, (vii) real time interactive traffic, (viii) unified communications traffic, (ix) background traffic, (x) location-based traffic, or (xi) critical communications traffic.

Example 7. The method of any of the preceding examples, wherein the traffic descriptor includes a traffic category identifier.

Example 8. The method of example 7, wherein the traffic category identifier includes a traffic descriptor component type identifier.

Example 9. The method of example 7, wherein the traffic category identifier includes a connection capabilities component type identifier.

Example 10. The method of any of examples 1-9, wherein the reporting information is included in a reporting information element included in a session establishment message.

Example 11. The method of any of examples 1-9, wherein the reporting information is included in a reporting information element included in a session modification message.

Example 12. The method of any of examples 1-9, wherein the reporting information is included in a session management message.

Example 13. The method of any of examples 1-9, wherein the reporting information is included in a registration request message.

Example 14. The method of any of examples 1-9, wherein the reporting information is included in a reporting information container included in an uplink message.

Example 15. The method of any of examples 7-14, wherein: the traffic category identifier is a first traffic category identifier; the traffic descriptor includes a second traffic category identifier; and the transmitting is responsive to determining: (i) that at least one of the first traffic category identifier or the second traffic category identifier matches a traffic category identifier for the application, and (ii) that the first traffic category identifier and the second traffic category identifier share a traffic category component type.

Example 16. The method of example 15, wherein the traffic category component type is an operator specific traffic category component type.

Example 17. The method of example 15, wherein the traffic category component type is a connection capability component type, and the at least one of the first traffic category identifier or the second traffic category identifier matches the traffic category identifier for the application when: (i) connection capability component values for at least one of the first traffic category identifier or the second traffic category identifier matches connection capability component values for the traffic category identifier for the application; or (ii) a connection capability component type identifier for at least one of the first traffic category identifier or the second traffic category identifier matches a connection capability component type identifier for the traffic category identifier for the application.

Example 18. The method of any of examples 7-14, wherein: the traffic category identifier is a first traffic category identifier; the traffic descriptor includes a second traffic category identifier; and the transmitting is responsive to determining: (i) one or more application identifiers are matched, (ii) one or more internet protocol (IP) descriptors are matched, (iii) one or more non-IP descriptors are matched, (iv) one or more data network names are matched, (v) one or more connection capabilities are matched, or (vi) one or more domain descriptors are matched.

Example 19. The method of any of examples 1-4, the method including: determining, based on the evaluation of the route selection policy rule, that the selection policy rule includes a reporting indication; wherein the transmitting is in response to the determining that the route selection policy rule includes the reporting indication.

Example 20. The method of example 19, wherein the reporting indication is a numerical reporting threshold, the method further including: generating a random reporting number; wherein the transmitting is further in response to determining that the random reporting number satisfies the numerical reporting threshold.

Example 21. The method of any of examples 1-4, wherein the route selection policy rule includes a reporting condition, the method including: determining, based on the evaluation of the route selection policy rule, that the reporting condition is fulfilled; wherein the transmitting is in response to the determining that the reporting condition is fulfilled.

Example 22. The method of example 21, wherein the reporting condition includes a condition associated with at least one of: (i) a location of the UE; (ii) a time of reporting; (iii) a presence of a traffic descriptor component for the route selection policy rule; (iv) a traffic descriptor component type for the route selection policy rule; (v) a traffic descriptor component value for the route selection policy rule; (vi) a presence of a route selection descriptor component for the route selection policy rule; (vii) a route selection descriptor component type for the route selection policy rule; or (viii) a route selection descriptor component value for the route selection policy rule.

Example 23. The method of example 21 or 22, wherein the reporting condition is included in a reporting descriptor for the route selection policy rule.

Example 24. The method of example 21 or 22, wherein the reporting condition is included in the traffic descriptor for the route selection policy rule.

Example 25. The method of example 21 or 22, wherein the reporting condition is included in a route selection descriptor for the route selection policy rule.

Example 26. A user equipment (UE) comprising processing hardware and configured to implement a method according to any of examples 1-25.

Example 27. A method for managing reporting for a route selection policy for a user equipment (UE) running an application, the method implemented in a node of a core network (CN) and comprising: configuring, by the processing hardware, a route selection policy rule based on at least one of: (i) UE subscription information, (ii) UE reporting capabilities, or (iii) UE subscriber consent; transmitting, by the processing hardware, the configured route selection policy rule; and receiving, by the processing hardware, reporting information from the UE based on the configured route selection policy rule.

Example 28. The method of example 27, wherein the configured route selection policy rule includes at least one of: (i) a traffic category, (ii) a reporting indication, or (iii) a reporting condition.

Example 29. The method of example 27 or 28, wherein the configuring is based on the UE subscription information, and the UE subscription information includes at least one of: (i) an indication of user consent for reporting; (ii) subscribed network slice selection data; or (iii) a subscribed data network name list.

Example 30. The method of example 27 or 28, wherein the configuring is based on the UE reporting capabilities, the method including: receiving, from the UE, an indication of the UE reporting capabilities; and generating, based on the indication of the UE reporting capabilities, an association between the UE and a policy control function associated with the route selection policy rule; wherein the configuring is further based on the association.

Example 31. The method of example 30, the method including: receiving, from the UE, an indication of user consent for reporting.

Example 32. The method of example 30, wherein the generating occurs at an access and mobility management function of the CN, the method including: transmitting an indication of the UE reporting capabilities to a policy control function of the CN; and storing, via the policy control function, the UE reporting capabilities.

Example 33. The method of example 27, wherein the configuring is based on the UE subscriber consent, the method including: receiving, from the UE, an indication of the UE subscriber consent; and storing the UE subscriber consent.

Example 34. The method of example 33, wherein the storing occurs at a unified data manager of the CN, the method including: transmitting, to the unified data manager, the indication of the UE subscriber consent.

Example 35. The method of example 33, wherein the receiving the indication of the UE subscriber consent includes: receiving a UE subscriber container including the UE subscriber consent.

Example 36. The method of example 33, wherein receiving the indication of the UE subscriber consent includes: receiving a registration request message including the indication of the UE subscriber consent.

Example 37. The method of example 33, wherein receiving the indication of the UE subscriber consent includes: receiving an uplink transport message including the indication of the UE subscriber consent.

Example 38. A core network (CN) node comprising processing hardware and configured to implement a method according to any of examples 27-37.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for supporting a route selection policy for a user equipment (UE) running an application, the method implemented in the UE and comprising:
evaluating a route selection policy rule received from a core network (CN) node;
determining, based on the evaluation of the route selection policy rule, that a traffic descriptor for the route selection policy rule includes one or more connection capabilities; and
transmitting, in response to the determining, route selection policy rule enforcement reporting information to the CN node in accordance with the route selection policy rule.

2. The method of claim 1, wherein the transmitting is based on a UE reporting preference indicating that the UE is to report the route selection policy rule enforcement reporting information.

3. The method of claim 1,
wherein the transmitting is further responsive to determining that a traffic category for the application matches a traffic category for the route selection policy rule.

4. The method of claim 3, wherein the traffic category for the route selection policy rule is at least one of: (i) internet protocol (IP) multimedia subsystem (IMS) traffic, (ii) internet traffic, (iii) internet of things (IoT) or machine-to-machine traffic, (iv) on demand downlink streaming traffic, (v) on demand uplink streaming traffic, (vi) vehicular communication traffic, (vii) real time interactive traffic, (viii) unified communications traffic, (ix) background traffic, (x) location-based traffic, or (xi) critical communications traffic.

5. The method of claim 1, wherein the route selection policy rule enforcement reporting information is included in a reporting information element included in a session establishment message.

6. The method of claim 1, wherein the route selection policy rule enforcement reporting information is included in a reporting information element included in a session modification message.

7. The method of claim 1, the method including:
the transmitting is further in response to determining that the route selection policy rule includes a reporting indication.

8. The method of claim 1, wherein the route selection policy rule includes a reporting condition, the method including:
the transmitting is further in response to determining that the reporting condition is fulfilled.

9. The method of claim 8, wherein the reporting condition is included in the traffic descriptor for the route selection policy rule.

10. (canceled)

11. A method for supporting a route selection policy for a user equipment (UE) running an application, the method implemented in a node of a core network (CN) and comprising:
configuring a route selection policy rule including a traffic descriptor that includes one or more connection capabilities for the UE;
transmitting the configured route selection policy rule to the UE; and
receiving, when the traffic descriptor includes the one or more connection capabilities for the UE, route selection policy rule enforcement reporting information from the UE in accordance with the configured route selection policy rule.

12. The method of claim 11, wherein the configured route selection policy rule includes at least one of: (i) a traffic category, (ii) a reporting indication, or (iii) a reporting condition.

13. The method of claim 11, the method including:
receiving, from the UE, an indication of the connection capabilities; and
generating, based on the indication of the connection capabilities, an association between the UE and a policy control function associated with the route selection policy rule;
wherein the configuring is further based on the association.

14. The method of claim 13, wherein the generating occurs at an access and mobility management function of the CN, the method including:
transmitting an indication of the connection capabilities to a policy control function of the CN; and
storing, via the policy control function, the connection capabilities.

15. (canceled)

16. An apparatus functioning as a user equipment (UE), the apparatus comprising:
processing hardware configured to:
evaluate a route selection policy rule received from a core network (CN) node;
determine, based on the evaluation of the route selection policy rule, that a traffic descriptor for the route selection policy rule includes one or more connection capabilities; and
transmit, in response to the determining, route selection policy rule enforcement reporting information to the CN node in accordance with the route selection policy rule.

17. The apparatus of claim 16, wherein the processing hardware configured to transmit the route selection policy rule enforcement reporting information is configured to transmit the route selection policy rule enforcement reporting information based on a UE reporting preference indicating that the UE is to report the route selection policy rule enforcement reporting information.

18. The apparatus of claim 16, wherein the processing hardware configured to transmit the route selection policy rule enforcement reporting information is further responsive to a determination that a traffic category for the application matches a traffic category for the route selection policy rule.

19. The apparatus of claim 16, wherein the route selection policy rule enforcement reporting information is included in a reporting information element included in a session establishment message.

20. The apparatus of claim 16, wherein the route selection policy rule enforcement reporting information is included in a reporting information element included in a session modification message.

21. The apparatus of claim 16, wherein the processing hardware configured to transmit the route selection policy rule enforcement reporting information is further responsive to a determination that the route selection policy rule includes a reporting indication.

22. The apparatus of claim 16, wherein the route selection policy rule includes a reporting condition, and the processing hardware configured to transmit the route selection policy rule enforcement reporting information is further responsive to a determination that the reporting condition is fulfilled.
